(19) United States
(12) Patent Application Publication
(10) Pub. No.: US 2019/0321862 A1
(43) Pub. Date: Oct. 24, 2019

(54) CLEANING APPARATUS

(71) Applicant: John Moulton, New Smyrna Beach, FL (US)

(72) Inventor: John Moulton, New Smyrna Beach, FL (US)

(21) Appl. No.: 15/961,538

(22) Filed: Apr. 24, 2018

(51) Int. Cl. B08B 1/00; A47L 1/12; A01K 63/10

(52) U.S. Cl. CPC B08B 1/006; A01K 63/10; A47L 1/12

(57) ABSTRACT

A cleaning apparatus has a first magnetic board device and a second magnetic board device. The first magnetic board device has a first plate body, a first magnet, a first fastening member and a first cleaning pad. The first plate body and the first cleaning pad are attached to each other via the first fastening member. The first magnet is disposed on the first plate body. The second magnetic board device has a second plate body, a second magnet, a second fastening member and a second cleaning pad. The second plate body and the second cleaning pad are attached to each other via the second fastening member. The second magnet is disposed on the second plate body. The first magnet and the second magnet are magnetically attracted to each other, such that the first cleaning pad and the second cleaning pad are located adjacent to and facing towards each other.

### FIELD OF THE INVENTION

The present invention relates generally to a cleaning apparatus. More particularly, the present invention relates to a cleaning apparatus with two magnetic board devices magnetically attracted to each other for cleaning a workpiece positioned therebetween.

### BACKGROUND OF THE INVENTION

A conventional cleaning tool for cleaning two surfaces of a window of a building, a fish tank or a vehicle has a controller member and a follower member. Typically, the controller member has a housing, a mat attached to the housing and a magnet disposed on the housing, the the follower member has a casing, a pad attached to the casing and a steel block disposed on the casing. The magnet of the controller member magnetically attracts the steel block of the follower member, such that the mat of the controller member and the pad of of the follower member are pressed against the two surfaces of the window. By dragging the controller member along one surface of the window, the follower member on the other surface of the window follows, thereby cleaning the two surfaces of the window with mat and the pad at the same time.

Technically, the steel block is composed mostly of an iron material, which is a ferromagnetic material, such that the steel block is magnetically attracted by the magnet due to the influence of the magnetic field of the magnet upon the iron material.

However, the magnetic attraction between the magnet and the steel block made of the iron material becomes distinctly weaker as the distance increases due to the iron material's low remanence.

It is therefore an objective of the present invention to provide a cleaning apparatus that is able to solve the above-mentioned problems.

### BRIEF DESCRIPTION OF THE DRAWINGS

FIG. 1 is a perspective view depicting a cleaning apparatus with a first magnetic board device and a second magnetic board device of the present invention.

FIG. 2 is another perspective view depicting the cleaning apparatus with the first magnetic board device and the second magnetic board device of the present invention.

FIG. 3 is a perspective view depicting the cleaning apparatus for cleaning a workpiece of the present invention.

FIG. 4 is another perspective view depicting the cleaning apparatus for cleaning the workpiece of the present invention.

FIG. 5 is a perspective view depicting the first magnetic board device connected with a handle device of the present invention.

FIG. 6 is a perspective view depicting the first magnetic board device connected with an extension grip device of the present invention.

FIG. 7 is a perspective view depicting the first magnetic board device connected with the handle device and the extension grip device of the present invention.

FIG. 8 is a perspective view depicting the first magnetic board device with a first magnetic attenuating member of the present invention.

FIG. 9 is a perspective view depicting the second magnetic board device with a second magnetic attenuating member of the present invention.

FIG. 10 is an exploded view depicting the cleaning apparatus having the first magnetic board device with the first magnetic attenuating member, the second magnetic board device with the second magnetic attenuating member, the handle device and the extension grip device of the present invention.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced without the implementation of some features as they are described. It should be understood that some details have not been described in detail in order to not unnecessarily obscure focus of the invention.

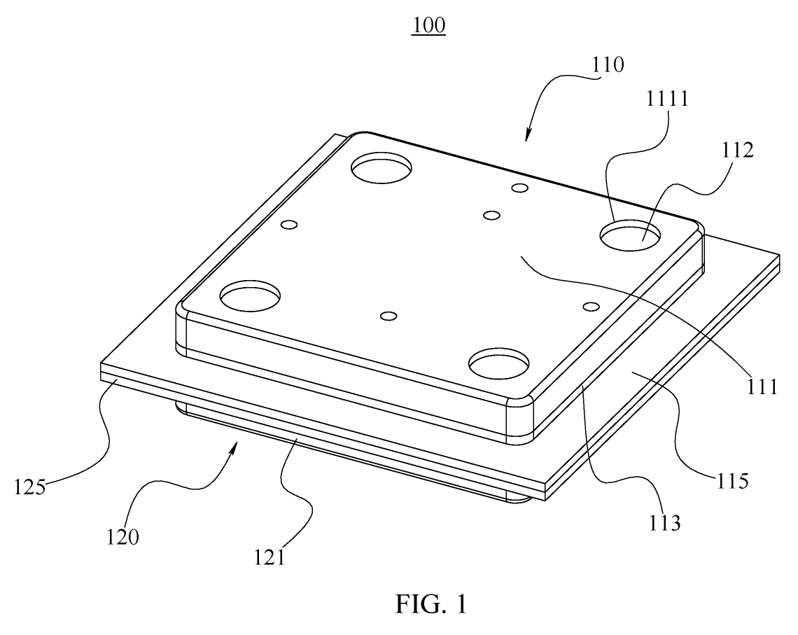

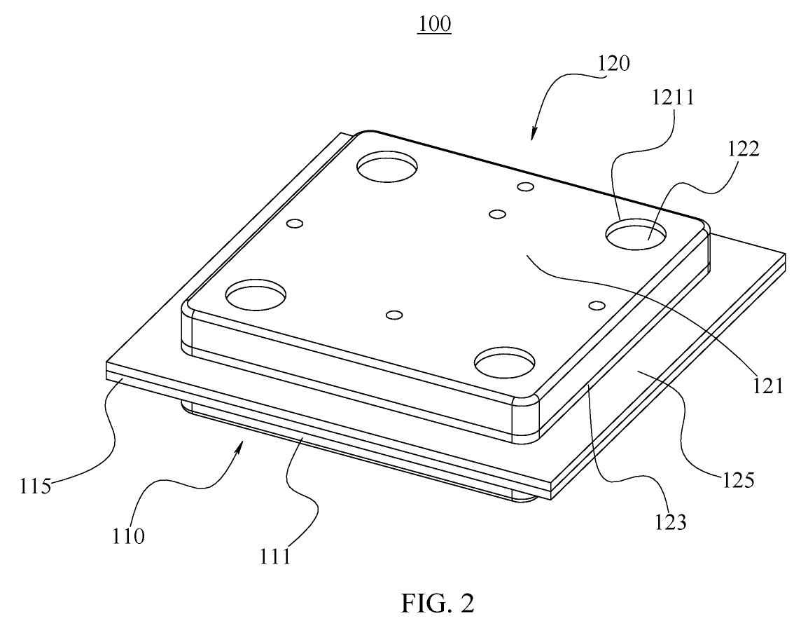

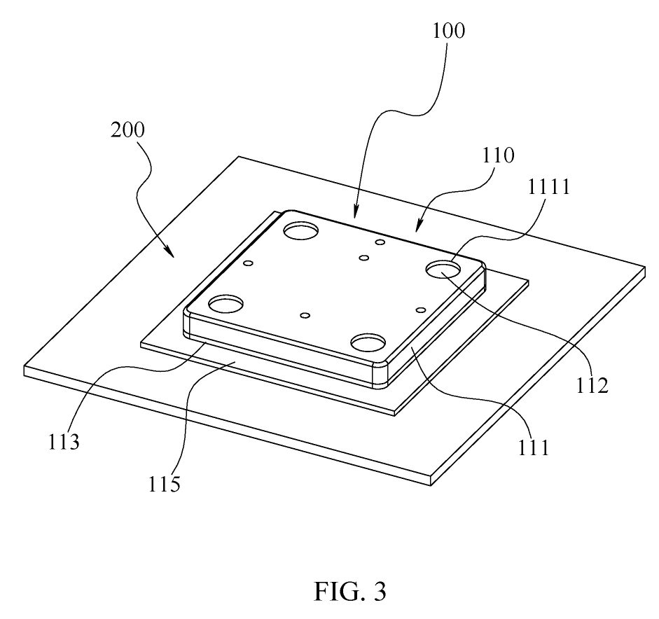

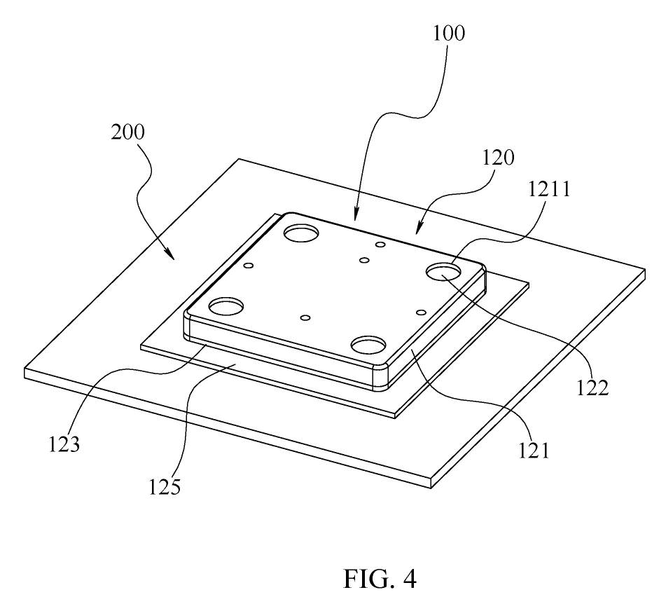

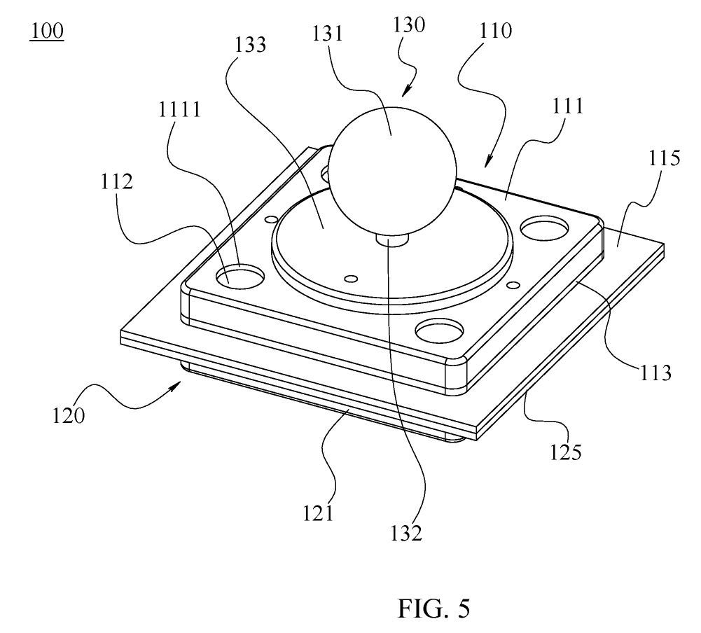

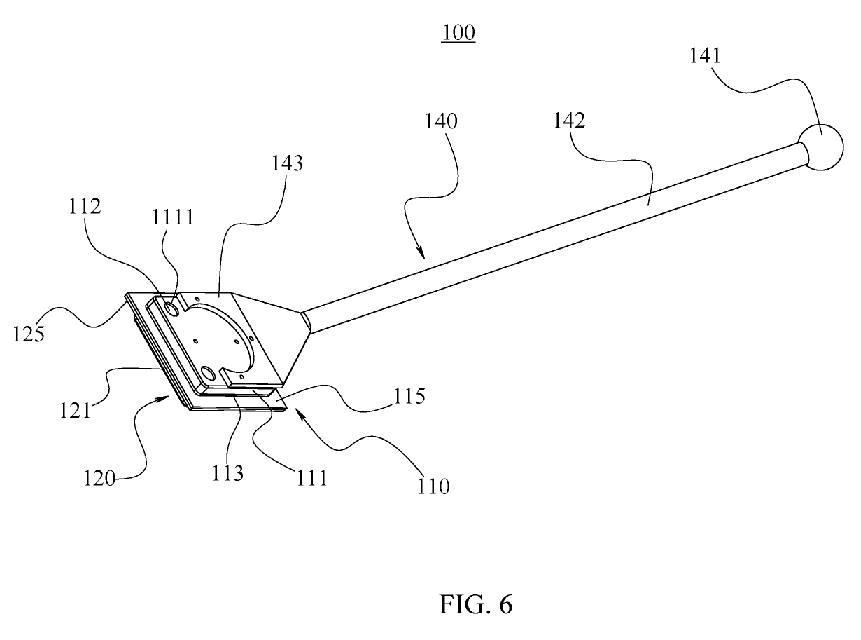

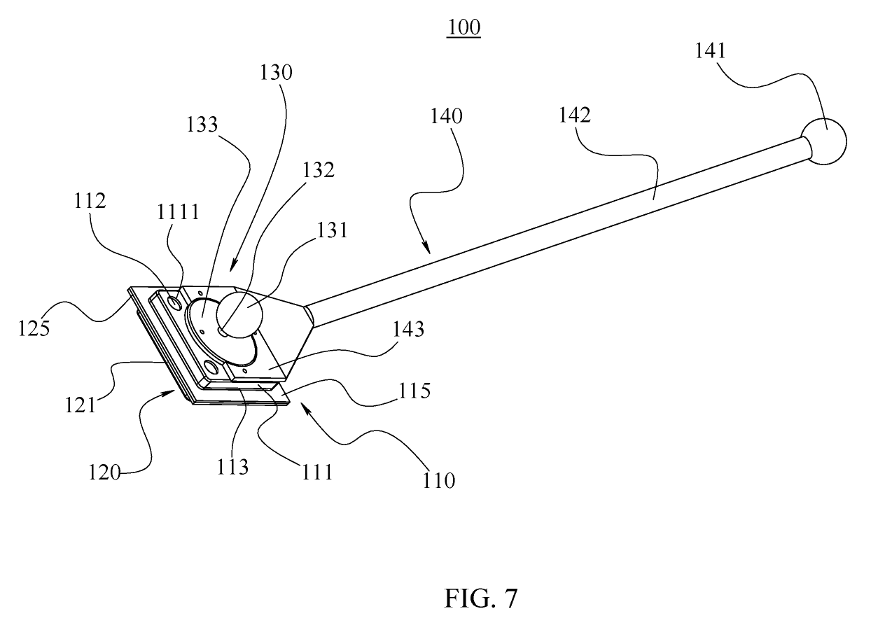

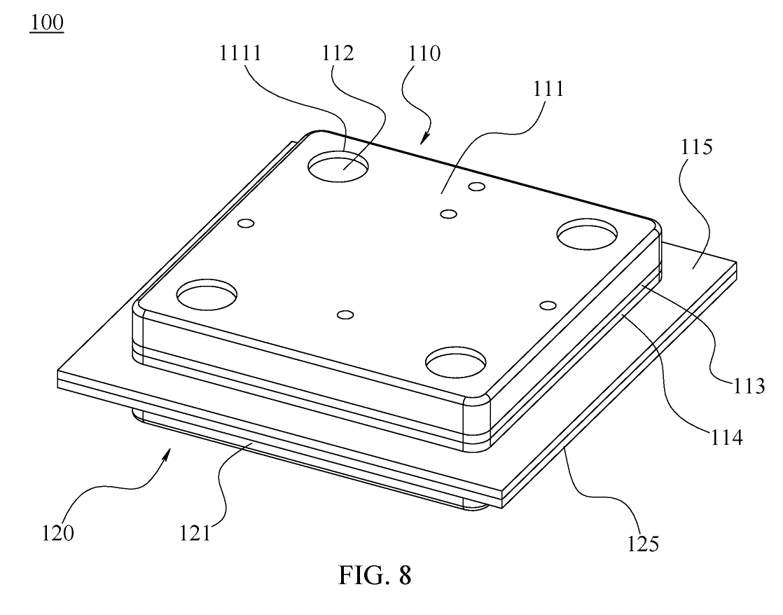

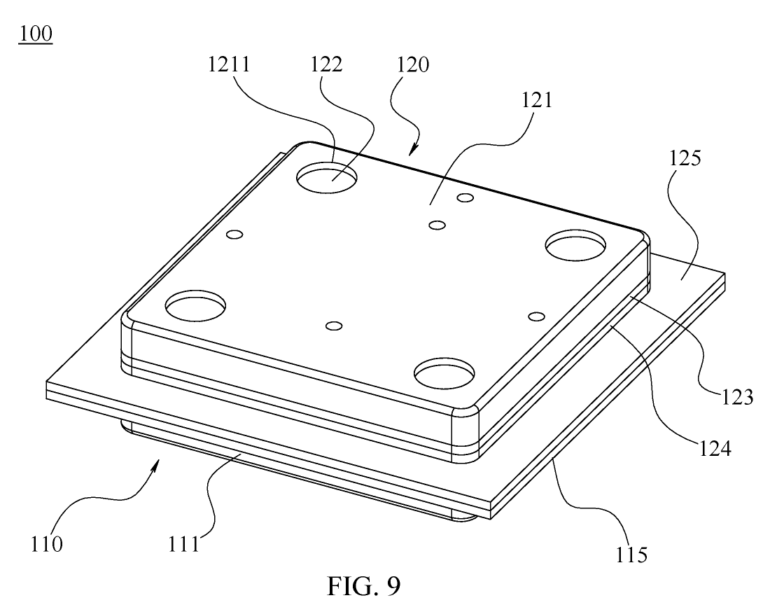

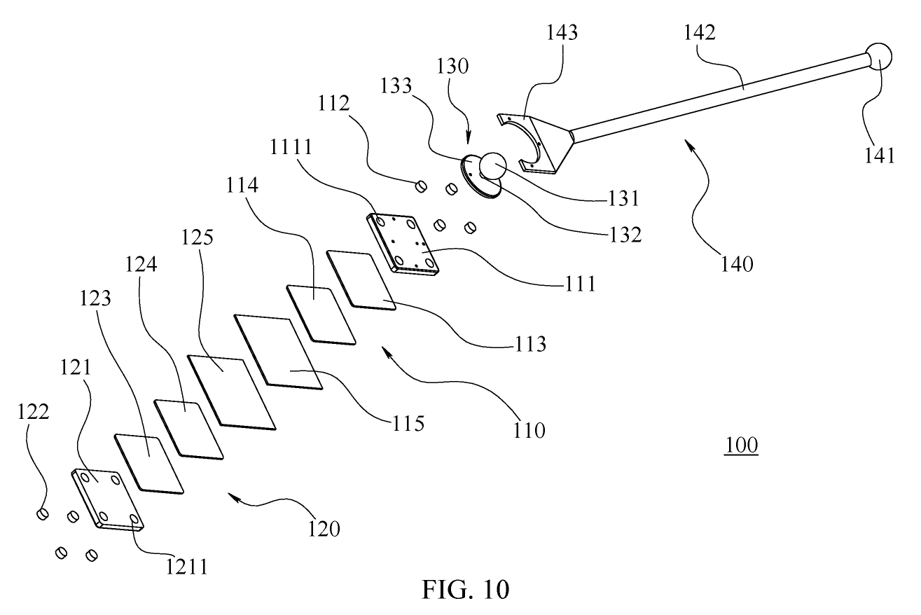

Please refer to FIGS. 1-10, the present invention provides a cleaning apparatus 100. The cleaning apparatus 100 is used to clean a workpiece 200. The workpiece 200 is, for instance, but not limited to, a building window or a vehicle windshield.

In an embodiment, the cleaning apparatus 100 comprises a first magnetic board device 110 and a second magnetic board device 120.

In this embodiment, the first magnetic board device 110 comprises a first plate body 111, a first magnet 112, a first fastening member 113 and a first cleaning pad 115. The first fastening member 113 is located in between the first plate body 111 and the first cleaning pad 115. The first plate body 111 and the first cleaning pad 115 are attached to each other via the first fastening member 113. The first magnet 112 is disposed on the first plate body 111.

In one aspect, the first plate body 111 is made of a flexible material, such as, but not limited to, a plastic material.

In one aspect, the first magnet 112 is attached to the first plate body 111 by using, for instance, but not limited to, adhesive, glue, cement, mucilage or paste.

In one aspect, the first magnet 112 is a rare-earth magnet which is a permanent magnet made from a rare-earth material.

In one aspect, the first fastening member 113 is made of, for instance, but not limited to, an adhesive material, a glue material, a cement material, a mucilage material or a paste material.

In one aspect, the first fastening member 113 comprises a first hook layer and a first loop layer. The first hook layer and the first loop layer are removably fastened to each other. In this aspect, one of the first hook layer and the first loop layer is attached to the first plate body 111, while the other one of the first hook layer and the first loop layer is attached to the first cleaning pad 115.

In one aspect, the first cleaning pad 115 is made of a fabric material or a microfiber material. In this aspect, the first fastening member 113 comprises the first hook layer, and the first hook layer is removably fastened to the first cleaning pad 115; alternatively, the first fastening member 113 comprises the first hook layer and the first loop layer, and the first loop layer is integrated with the first cleaning pad 115.

The second magnetic board device 120 comprises a second plate body 121, a second magnet 122, a second fastening member 123 and a second cleaning pad 125. The second fastening member 123 is located in between the second plate body 121 and the second cleaning pad 125. The second plate body 121 and the second cleaning pad 125 are attached to each other via the second fastening member 123. The second magnet 122 is disposed on the second plate body 121.

In one aspect, the second plate body 121 is made of a flexible material, such as, but not limited to, a plastic material.

In one aspect, the second magnet 122 is attached to the second plate body 121 by using, for instance, but not limited to, adhesive, glue, cement, mucilage or paste.

In one aspect, the second magnet 122 is a rare-earth magnet which is a permanent magnet made from a rare-earth material.

In one aspect, the second fastening member 123 is made of, for instance, but not limited to, an adhesive material, a glue material, a cement material, a mucilage material or a paste material.

In one aspect, the second fastening member 123 comprises a second hook layer and a second loop layer. The second hook layer and the second loop layer are removably fastened to each other. In this aspect, one of the second hook layer and the second loop layer is attached to the second plate body 121, while the other one of the second hook layer and the second loop layer is attached to the second cleaning pad 125.

In one aspect, the second cleaning pad 125 is made of a fabric material or a microfiber material. In this aspect, the second fastening member 123 comprises the second hook layer, and the second hook layer is removably fastened to the second cleaning pad 125; alternatively, the second fastening member 123 comprises the second hook layer and the second loop layer, and the second loop layer is integrated with the second cleaning pad 125.

The first magnet 112 and the second magnet 122 are magnetically attracted to each other. Specifically, the first magnet 112 and the second magnet 122 each has two opposing poles. Particularly, the first magnet 112 has a first north pole and a first south pole, and the second magnet 122 has a second north pole and a second south pole. Accordingly, the first magnet 112 and the second magnet 122 are magnetically attracted to each other by the first north pole and the second south pole being magnetically attracted to each other, or by the first south pole and the second north pole being magnetically attracted to each other.

The first magnetic board device 110 and the second magnetic board device 120 are magnetically attracted to each other by the first magnet 112 and the second magnet 122 being magnetically attracted to each other.

The first cleaning pad 115 and the second cleaning pad 125 are located adjacent to and facing towards each other when the first magnet 112 and the second magnet 122 are magnetically attracted to each other. Additionally, the first cleaning pad 115 and the second cleaning pad 125 are pressed against each other by the first magnet 112 and the second magnet 122 being magnetically attracted to each other when no obstruction is positioned in between the first cleaning pad 115 and the second cleaning pad 125.

In order to clean the workpiece 200 by using the cleaning apparatus 100, first of all, the first cleaning pad 115 is pressed against one of two opposing surfaces of the workpiece 200 while the second cleaning pad 125 is pressed against the other one of the two opposing surfaces of the workpiece 200 by the first magnet 112 and the second magnet 122 being magnetically attracted to each other. Then, rendering the first magnetic board device 110 moving over the one of the two opposing surfaces of the workpiece 200 causes the second magnetic board device 120 moving over the other one of the two opposing surfaces of the workpiece 200 via a magnetic force created by the first magnet 112 and the second magnet 122. Alternatively, rendering the second magnetic board device 120 moving over the other one of the two opposing surfaces of the workpiece 200 causes the first magnetic board device 110 moving over the one of the two opposing surfaces of the workpiece 200 via the magnetic force created by the first magnet 112 and the second magnet 122. Accordingly, the two opposing surfaces of the workpiece 200 are simultaneously cleaned by the first cleaning pad 115 and the second cleaning pad 125.

For example, when the workpiece 200 is the vehicle windshield, the first cleaning pad 115 is pressed against an outside surface of the vehicle windshield while the second cleaning pad 125 is pressed against an inside surface of the vehicle windshield; when the workpiece 200 is the building window, the first cleaning pad 115 is pressed against an inside surface of the building window while the second cleaning pad 125 is pressed against an outside surface of the building window.

In an embodiment, the first plate body 111 comprises a first recess 1111, and the second plate body 121 comprises a second recess 1211. The first magnet 112 is embedded within the first recess 1111. The second magnet 122 is embedded within the second recess 1211. In one aspect, the first magnet 112 is entirely embedded within the first recess 1111, and the second magnet 122 is entirely embedded within the second recess 1211. In another aspect, the first magnet 112 is partially embedded within the first recess 1111, and the second magnet 122 is partially embedded within the second recess 1211.

In an embodiment, the cleaning apparatus 100 further comprises a handle device 130. The handle device 130 is connected with the first plate body 111. The first plate body 111 is located in between the handle device 130 and the first fastening member 113.

In one aspect, the handle device 130 is located at a center region of the first plate body 111. In this aspect, the first magnet 112 is located at a peripheral region of the first plate body 111; alternatively, the first magnet 112 is located at the center region of the first plate body 111, and is located under the handle device 130.

In this embodiment, the handle device 130 comprises a first knob 131, a first neck 132 and a first base 133. The first knob 131 is of substantially-spherical-shaped, such that the first knob 131 is ergonomic and provides easy comfort. The first neck 132 is connected in between the first knob 131 and the first base 133. The first base 133 is connected with the first plate body 111. The first neck 132 is erected from the first base 133. In one aspect, the first neck 132 is intersectionally or perpendicularly connected with the first base 133.

In an embodiment, the handle device 130 is fixedly connected with the first plate body 111. In this embodiment, the first base 133 is fixedly connected with the first plate body 111.

In an embodiment, the handle device 130 is removably connected with the first plate body 111 by using, for instance, but not limited to, screw, bolt, adhesive, glue, cement, mucilage or paste. In this embodiment, the first base 133 is removably connected with the first plate body 111 by using, for instance, but not limited to, screw, bolt, adhesive, glue, cement, mucilage or paste.

In an embodiment, the cleaning apparatus 100 further comprises an extension grip device 140. The extension grip device 140 is connected with the first plate body 111. The first plate body 111 is located in between the extension grip device 140 and the first fastening member 113. The extension grip device 140 allows for longer reach on the workpiece 200.

In one aspect, the extension grip device 140 is located at the peripheral region of the first plate body 111. In this aspect, the first magnet 112 is located at the peripheral region of the first plate body 111, and is located under the extension grip device 140; alternatively, the first magnet 112 is located at the center region of the first plate body 111.

In this embodiment, the extension grip device 140 comprises a second knob 141, a second neck 142 and a second base 143. The second knob 141 is of substantially-spherical-shaped, such that the second knob 141 is ergonomic and provides easy comfort. The second neck 142 is connected in between the second knob 141 and the second base 143. The second base 143 is connected with the first plate body 111. The second neck 142 is erected from the second base 143. In one aspect, the second neck 142 is intersectionally or perpendicularly connected with the second base 143.

In an embodiment, the extension grip device 140 is fixedly connected with the first plate body 111. In this embodiment, the second base 143 is fixedly connected with the first plate body 111.

In an embodiment, the extension grip device 140 is removably connected with the first plate body 111 by using, for instance, but not limited to, screw, bolt, adhesive, glue, cement, mucilage or paste. In this embodiment, the second base 143 is removably connected with the first plate body 111 by using, for instance, but not limited to, screw, bolt, adhesive, glue, cement, mucilage or paste.

In an embodiment, the handle device 130 and the extension grip device 140 are located adjacent to each other. In this embodiment, the second neck 142 is longer than the first neck 132. In this embodiment, the first base 133 and the extension grip device 140 are located adjacent to each other, and the second base 143 and the handle device 130 are located adjacent to each other. In other words, the first base 133 and the second base 143 are located adjacent to each other.

In one aspect, the second base 143 surrounds the first base 133. In this aspect, the handle device 130 is located at the center region of the first plate body 111 while the extension grip device 140 is located at the peripheral region of the first plate body 111. In an embodiment, the first magnetic board device 110 further comprises a first magnetic attenuating member 114. The first fastening member 113 is located in between the first plate body 111 and the first magnetic attenuating member 114. The first magnetic attenuating member 114 is located in between the first fastening member 113 and the first cleaning pad 115. The first plate body 111 and the first cleaning pad 115 are attached to each other via the first fastening member 113 and the first magnetic attenuating member 114. The first magnetic attenuating member 114 is used to increase a distance between the first magnet 112 and the second magnet 122 when the first magnet 112 and the second magnet 122 are magnetically attracted to each other, such that the magnetic force created by the first magnet 112 and the second magnet 122 is weakened in the event the cleaning apparatus 100 pulls too hard on the workpiece 200, i.e., the magnetic force between the first magnet 112 and the second magnet 122 is too strong.

In one aspect, the first magnetic attenuating member 114 is made of, for instance, but not limited to, an adhesive material, a glue material, a cement material, a mucilage material or a paste material.

In one aspect, the first magnetic attenuating member 114 comprises a first hook part and a first loop part. The first hook part and the first loop part are removably fastened to each other. In this aspect, one of the first hook part and the first loop part is attached to the first fastening member 113 while the other one of the first hook part and the first loop part is attached to the first cleaning pad 115.

In one aspect, the first hook layer is attached to the first plate body 111, the first loop layer and the first hook part are removably fastened to each other, and the first loop part is attached to or integrated with the first cleaning pad 115. Alternatively, the first loop layer is attached to the first plate body 111, the first hook layer and the first loop part are removably fastened to each other, and the first hook part is attached to the first cleaning pad 115.

In an embodiment, the second magnetic board device 120 further comprises a second magnetic attenuating member 124. The second fastening member 123 is located in between second plate body 121 and the second magnetic attenuating member 124. The second magnetic attenuating member 124 is located in between the second fastening member 123 and the second cleaning pad 125. The second plate body 121 and the second cleaning pad 125 are attached to each other via the second fastening member 123 and the second magnetic attenuating member 124. The second magnetic attenuating member 124 is used to increase the distance between the first magnet 112 and the second magnet 122 when the first magnet 112 and the second magnet 122 are magnetically attracted to each other, such that the magnetic force created by the first magnet 112 and the second magnet 122 is weakened in the event the cleaning apparatus 100 pulls too hard on the workpiece 200, i.e., the magnetic force between the first magnet 112 and the second magnet 122 is too strong.

In one aspect, the second magnetic attenuating member 124 is made of, for instance, but not limited to, an adhesive material, a glue material, a cement material, a mucilage material or a paste material.

In one aspect, the second magnetic attenuating member 124 comprises a second hook part and a second loop part. The second hook part and the second loop part are removably fastened to each other. In this aspect, one of the second hook part and the second loop part is attached to the second fastening member 123 while the other one of the second hook part and the second loop part is attached to the second cleaning pad 125.

In one aspect, the second hook layer is attached to the second plate body 121, the second loop layer and the second hook part are removably fastened to each other, and the second loop part is attached to or integrated with the second cleaning pad 125. Alternatively, the second loop layer is attached to the second plate body 121, the second hook layer and the second loop part are removably fastened to each other, and the second hook part is attached to the second cleaning pad 125.

In an embodiment, the first magnetic board device 110 comprises the first magnetic attenuating member 114, and the second magnetic board device 120 comprises the second magnetic attenuating member 124.

In an embodiment, the first magnetic board device 110 comprises a plurality of first magnetic attenuating members 114.

In an embodiment, the second magnetic board device 120 comprises a plurality of second magnetic attenuating members 124.

In an embodiment, the first magnetic board device 110 comprises the plurality of first magnetic attenuating members 114, and the second magnetic board device 120 comprises the plurality of second magnetic attenuating members 124.

In an embodiment, the first magnetic board device 110 comprises a plurality of first magnets 112, and the second magnetic board device 120 comprises a plurality of second magnets 122.

In this embodiment, the plurality of first north poles of the plurality of first magnets 112 face towards the plurality of second south poles of the plurality of second magnets 122; alternatively, the plurality of first south poles of the plurality of first magnets 112 face towards the plurality of second north poles of the plurality of second magnets 122.

In this embodiment, the plurality of first magnets 112 are disposed on the first plate body 111, the plurality of second magnets 122 disposed on the second plate body 121, the plurality of first magnets 112 are separate from one another, and the plurality of second magnets 122 are separate from one another. The first plate body 111 comprises a plurality of first recesses 1111, and the second plate body 121 comprises a plurality of second recesses 1211. The plurality of first recesses 1111 are separate from one another, and the plurality of second recesses 1211 are separate from one another. A corresponding first magnet among the plurality of first magnets 112 is entirely or partially embedded within a corresponding first recess among the plurality of first recesses 1111, and a corresponding second magnet among the plurality of second magnets 122 is entirely or partially embedded within a corresponding second recess among the plurality of second recesses 1211.

Although the invention has been explained in relation to its preferred embodiment, it is to be understood that many other possible modifications and variations can be made without departing from the spirit and scope of the invention.

What is claimed is:

1. A cleaning apparatus comprising:
a first magnetic board device;
a second magnetic board device;
the first magnetic board device comprising a first plate body, a first magnet, a first fastening member and a first cleaning pad;
the first fastening member being located in between the first plate body and the first cleaning pad;
the first plate body and the first cleaning pad being attached to each other via the first fastening member;
the first magnet being disposed on the first plate body;
the second magnetic board device comprising a second plate body, a second magnet, a second fastening member and a second cleaning pad;
the second fastening member being located in between the second plate body and the second cleaning pad;
the second plate body and the second cleaning pad being attached to each other via the second fastening member;
the second magnet being disposed on the second plate body;
the first magnet and the second magnet being magnetically attracted to each other;
the first magnetic board device and the second magnetic board device being magnetically attracted to each other by the first magnet and the second magnet being magnetically attracted to each other; and
the first cleaning pad and the second cleaning pad being located adjacent to and facing towards each other in response to the first magnet and the second magnet being magnetically attracted to each other.

2. The cleaning apparatus as claimed in claim 1 comprising:
the first plate body comprising a first recess;
the second plate body comprising a second recess;
the first magnet being embedded within the first recess; and
the second magnet being embedded within the second recess.

3. The cleaning apparatus as claimed in claim 1 comprising:
a handle device;
the handle device being connected with the first plate body; and
the first plate body being located in between the handle device and the first fastening member.

4. The cleaning apparatus as claimed in claim 3 comprising:
the handle device comprising a first knob, a first neck and a first base;
the first knob being of substantially-spherical-shaped;
the first neck being connected in between the first knob and the first base; and
the first base being connected with the first plate body.

5. The cleaning apparatus as claimed in claim 3 comprising:
the handle device being removably connected with the first plate body.

6. The cleaning apparatus as claimed in claim 1 comprising:
an extension grip device;
the extension grip device being connected with the first plate body; and
the first plate body being located in between the extension grip device and the first fastening member.

7. The cleaning apparatus as claimed in claim 6 comprising:
the extension grip device comprising a second knob, a second neck and a second base;
the second knob being of substantially-spherical-shaped;
the second neck being connected in between the second knob and the second base; and
the second base being connected with the first plate body.

8. The cleaning apparatus as claimed in claim 6 comprising:
the extension grip device being removably connected with the first plate body.

9. The cleaning apparatus as claimed in claim 1 comprising:
the first magnetic board device comprising a first magnetic attenuating member;
the first fastening member being located in between the first plate body and the first magnetic attenuating member;
the first magnetic attenuating member being located in between the first fastening member and the first cleaning pad; and
the first plate body and the first cleaning pad being attached to each other via the first fastening member and the first magnetic attenuating member.

10. The cleaning apparatus as claimed in claim 1 comprising:
the second magnetic board device comprising a second magnetic attenuating member;
the second fastening member being located in between the second plate body and the second magnetic attenuating member;
the second magnetic attenuating member being located in between the second fastening member and the second cleaning pad; and
the second plate body and the second cleaning pad being attached to each other via the second fastening member and the second magnetic attenuating member.

11. A cleaning apparatus comprising:
a first magnetic board device;
a second magnetic board device;
a handle device;
an extension grip device;
the first magnetic board device comprising a first plate body, a first magnet, a first fastening member and a first cleaning pad;
the first fastening member being located in between the first plate body and the first cleaning pad;
the first plate body and the first cleaning pad being attached to each other via the first fastening member;
the first magnet being disposed on the first plate body;
the second magnetic board device comprising a second plate body, a second magnet, a second fastening member and a second cleaning pad;
the second fastening member being located in between the second plate body and the second cleaning pad;
the second plate body and the second cleaning pad being attached to each other via the second fastening member;
the second magnet being disposed on the second plate body;
the first magnet and the second magnet being magnetically attracted to each other;
the first magnetic board device and the second magnetic board device being magnetically attracted to each other by the first magnet and the second magnet being magnetically attracted to each other;
the first cleaning pad and the second cleaning pad being located adjacent to and facing towards each other in response to the first magnet and the second magnet being magnetically attracted to each other;
the handle device being connected with the first plate body;
the first plate body being located in between the handle device and the first fastening member;
the extension grip device being connected with the first plate body;
the first plate body being located in between the extension grip device and the first fastening member; and
the handle device and the extension grip device being located adjacent to each other.

12. The cleaning apparatus as claimed in claim 11 comprising:
the first plate body comprising a first recess;
the second plate body comprising a second recess;
the first magnet being embedded within the first recess; and
the second magnet being embedded within the second recess.

13. The cleaning apparatus as claimed in claim 11 comprising:
the handle device comprising a first knob, a first neck and a first base;
the first knob being of substantially-spherical-shaped;
the first neck being connected in between the first knob and the first base;
the first base being connected with the first plate body; and
the first base and the extension grip device being located adjacent to each other.

14. The cleaning apparatus as claimed in claim 11 comprising:
the handle device being removably connected with the first plate body.

15. The cleaning apparatus as claimed in claim 11 comprising:
the extension grip device comprising a second knob, a second neck and a second base;
the second knob being of substantially-spherical-shaped;
the second neck being connected in between the second knob and the second base;
the second base being connected with the first plate body; and
the second base and the handle device being located adjacent to each other.

16. The cleaning apparatus as claimed in claim 11 comprising:
the extension grip device being removably connected with the first plate body.

17. The cleaning apparatus as claimed in claim 11 comprising:
the first magnetic board device comprising a first magnetic attenuating member;
the second magnetic board device comprising a second magnetic attenuating member;
the first fastening member being located in between the first plate body and the first magnetic attenuating member;
the first magnetic attenuating member being located in between the first fastening member and the first cleaning pad;
the second fastening member being located in between the second plate body and the second magnetic attenuating member;
the second magnetic attenuating member being located in between the second fastening member and the second cleaning pad;
the first plate body and the first cleaning pad being attached to each other via the first fastening member and the first magnetic attenuating member; and
the second plate body and the second cleaning pad being attached to each other via the second fastening member and the second magnetic attenuating member.

18. A cleaning apparatus comprising:
a first magnetic board device;
a second magnetic board device;
a handle device;
an extension grip device;
the first magnetic board device comprising a first plate body, a first magnet, a first fastening member, a first magnetic attenuating member and a first cleaning pad;
the first fastening member being located in between the first plate body and the first magnetic attenuating member;
the first magnetic attenuating member being located in between the first fastening member and the first cleaning pad;
the first plate body and the first cleaning pad being attached to each other via the first fastening member and the first magnetic attenuating member;
the first magnet being disposed on the first plate body;
the first plate body comprising a first recess;
the first magnet being embedded within the first recess;
the second magnetic board device comprising a second plate body, a second magnet, a second fastening member, a second magnetic attenuating member and a second cleaning pad;
the second fastening member being located in between the second plate body and the second magnetic attenuating member;
the second magnetic attenuating member being located in between the second fastening member and the second cleaning pad;
the second plate body and the second cleaning pad being attached to each other via the second fastening member and the second magnetic attenuating member;
the second magnet being disposed on the second plate body;
the second plate body comprising a second recess;
the second magnet being embedded within the second recess;
the first magnet and the second magnet being magnetically attracted to each other;
the first magnetic board device and the second magnetic board device being magnetically attracted to each other by the first magnet and the second magnet being magnetically attracted to each other;
the first cleaning pad and the second cleaning pad being located adjacent to and facing towards each other in response to the first magnet and the second magnet being magnetically attracted to each other;
the handle device being removably connected with the first plate body;
the first plate body being located in between the handle device and the first fastening member;
the extension grip device being removably connected with the first plate body;
the first plate body being located in between the extension grip device and the first fastening member; and
the handle device and the extension grip device being located adjacent to each other.

19. The cleaning apparatus as claimed in claim 18 comprising:
the handle device comprising a first knob, a first neck and a first base;
the first knob being of substantially-spherical-shaped;
the first neck being connected in between the first knob and the first base;
the first base being removably connected with the first plate body; and
the first base and the extension grip device being located adjacent to each other.

20. The cleaning apparatus as claimed in claim 18 comprising:
the extension grip device comprising a second knob, a second neck and a second base;
the second knob being of substantially-spherical-shaped;
the second neck being connected in between the second knob and the second base;
the second base being removably connected with the first plate body; and
the second base and the handle device being located adjacent to each other.
